(19) United States
(12) Patent Application Publication
(10) Pub. No.: US 2019/0050270 A1
(43) Pub. Date: Feb. 14, 2019

(54) SIMULTANEOUS MULTITHREADING WITH CONTEXT ASSOCIATIONS

(71) Applicant: Intel Corporation, Santa Clara, CA (US)

(72) Inventors: Eliezer Tamir, Jerusalem (IL); Eliel Louzoun, Jerusalem (IL); Ben-Zion Friedman, Jerusalem (IL)

(73) Assignee: Intel Corporation, Santa Clara, CA (US)

(21) Appl. No.: 16/007,330

(22) Filed: Jun. 13, 2018

(51) Int. Cl. G06F 9/50; G06F 9/455

(52) U.S. Cl. CPC G06F 9/5077; G06F 9/45533; G06F 9/45508

(57) ABSTRACT

Disclosed herein are systems, devices, and methods for simultaneous multithreading (SMT) with context associations. For example, in some embodiments, a computing device may include: one or more physical cores; and SMT logic to manage multiple logical cores per physical core such that operations of a first computing context are to be executed by a first logical core associated with the first computing context and operations of a second computing context are to be executed by a second logical core associated with the second computing context, wherein the first logical core and the second logical core share a common physical core.

### BACKGROUND

Computing devices may include one or more compute cores, which may themselves include one or more execution units (e.g., arithmetic units, load-store units, etc.). Different ones of these execution units may perform different operations.

### BRIEF SUMMARY OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIGS. 1-5 are block diagrams of context associative simultaneous multithreading (CASMT) computing devices, in accordance with various embodiments.

FIGS. 6-9 are flow diagrams illustrating example methods of operating a CASMT computing device, in accordance with various embodiments.

FIG. 10 is a block diagram of a CASMT computing device, in accordance with various embodiments.

FIG. 11 is a block diagram of a CASMT computing device including multiple processor systems, in accordance with various embodiments.

FIG. 12 is a block diagram of a computing system including a data center with CASMT computing devices in communication with client devices, in accordance with various embodiments.

FIG. 13 is a block diagram of an example computing device, in accordance with various embodiments.

### DETAILED DESCRIPTION

Disclosed herein are systems, devices, and methods for simultaneous multithreading (SMT) with context associations. For example, in some embodiments, a computing device may include: one or more physical cores; and SMT logic to manage multiple logical cores per physical core such that operations of a first computing context are to be executed by a first logical core associated with the first computing context and operations of a second computing context are to be executed by a second logical core associated with the second computing context, wherein the first logical core and the second logical core share a common physical core.

SMT techniques may improve utilization of physical processing units (e.g., processing cores or physical execution units) by multiplexing commands from several processes per physical processing unit. SMT logic may present an operating system (OS) of a computing device with several (e.g., two or more) “logical” or “virtual” execution units, which may share an underlying physical processing unit. In this manner, several “logical” processors are implemented using one “physical” processor.

In some settings, SMT may improve overall performance of a computing device at a marginally larger hardware cost (e.g., a larger die area and a larger number of registers). For example, for workloads that cause many input/output (I/O) and/or memory access stalls (e.g., due to busy physical disks, queries that return large data sets, cache misses, or the native access latency of the medium), SMT may substantially improve performance. However, for other workloads (e.g., those designed for low latency), performing SMT techniques may increase maximal latency and introduce undesirable unpredictability in system performance.

Disclosed herein are systems, devices, and methods for augmenting SMT functionality in new ways to achieve performance improvements not previously contemplated. In particular, disclosed herein are systems, devices, and methods in which different software execution contexts are associated with different instances of the logical cores “generated’ as part of an SMT technique; one logical core may be used to run code for one software execution context (e.g., user code) and another, different logical core may be used to run code for a different software execution context (e.g., OS code).

Enforced associations between different software execution contexts and different SMT logical cores may improve performance for workloads that involve many context switches because conventional operations required to save and restore the software execution contexts need not be performed. For example, in virtualized environments that have a significant time and memory cost when switching between a virtual machine (VM) and the virtual machine manager (VMM), significant performance improvements may be observed with the systems, devices, and methods disclosed herein.

In the following detailed description, reference is made to the accompanying drawings that form a part hereof wherein like numerals designate like parts throughout, and in which is shown, by way of illustration, embodiments that may be practiced. Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The description uses the phrases “in an embodiment” or “in embodiments,” which may each refer to one or more of the same or different embodiments. Furthermore, the terms “comprising,” “including,” “having,” and the like, as used with respect to embodiments of the present disclosure, are synonymous. As used herein, the term “logic” may refer to, be part of, or include an application-specific integrated circuit (ASIC), an electronic circuit, and optical circuit, a processor (shared, dedicated, or group), and/or memory (shared, dedicated, or group) that execute one or more software or firmware programs, a combinational logic circuit, and/or other suitable hardware that provide/s the described functionality. The accompanying drawings are not necessarily drawn to scale.

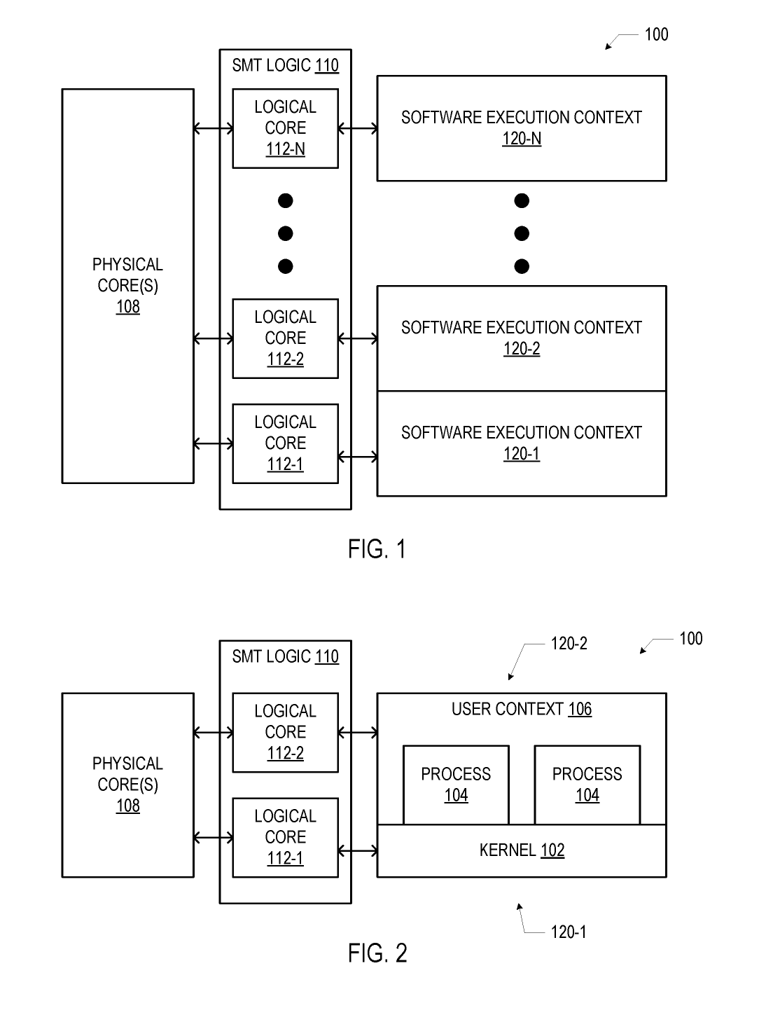

FIG. 1 is a block diagram of a context associative simultaneous multithreading (CASMT) computing device, in accordance with various embodiments. The CASMT computing device 100 includes one or more physical cores 108, simultaneous multithreading (SMT) logic 110, and N different software execution contexts 120 (identified as software execution contexts 120-1, 120-2, . . . , 120-N). The value of N may be two or greater.

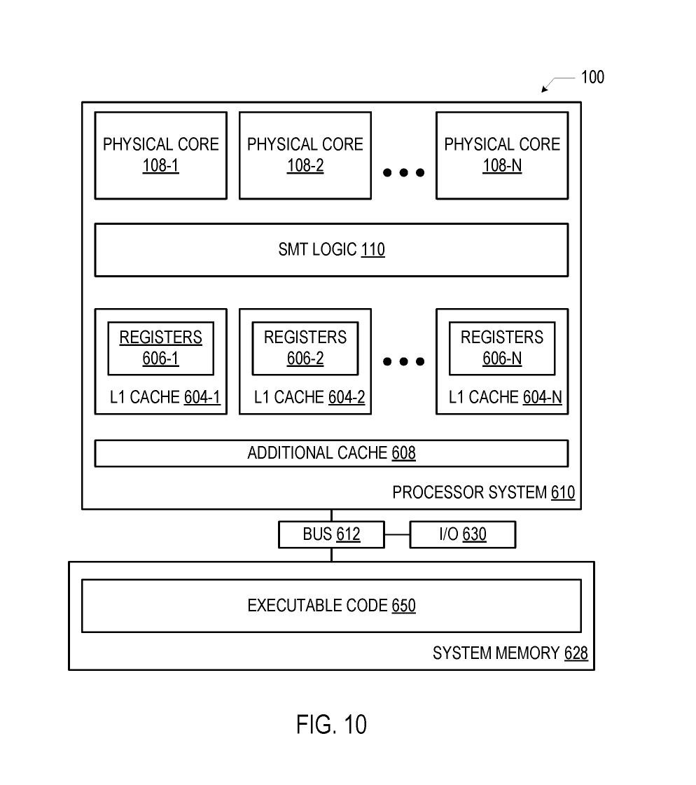

The physical cores 108 may include one or more physical cores. In some embodiments, the physical cores 108 may be processing cores. A processing core may include multiple execution units (e.g. one or more arithmetic logic units, load-store units, vector processors, and/or floating point units), each of which is responsible for handling a subset of the programming commands defined in the instruction set architecture (ISA). In some embodiments, the physical cores 108 may be part of a multi-core processor, multiple single-core processors, or a combination thereof. In some embodiments, the physical cores 108 may be part of a central processing unit (CPU), digital signal processor (DSP), system on a chip (SoC), or a combination thereof. The physical cores 108 may include one or more arithmetic logic units, load-store units, vector processors, and/or floating point units. As used herein, the term “physical core” refers to a processing core or a collection of one or more execution units (e.g., any of the execution units described above). Further examples of the physical cores 108 are discussed further below with reference to FIG. 10.

As used herein, a “software execution context 120” may refer to a set of capabilities that the architecture presents to programs executing on the CASMT computing device 100, including the OS. Such a set of capabilities would have been provided by a processing core in a computing device without SMT. A software execution context 120 may be associated with a particular set of storage locations (e.g., registers) that are used by executable code during the execution of that code. A number of examples of software execution contexts 120 are discussed below with reference to FIGS. 2-5 and FIGS. 6-9, including kernel contexts, user contexts, VMMs, VMs, and containers.

The SMT logic 110 may present a single physical core 108 as multiple logical cores 112 (shown in FIG. 1 as logical cores 112-1, 112-2, . . . , 112-N), and may multiplex commands from several processes per physical core 108 (e.g., per physical execution unit of a physical core 108) by directing execution of different ones of the processes to different ones of the logical cores 112. In particular, the SMT logic 110 may present a single physical core 108 as multiple logical cores 112 to one or more of the software execution contexts 120; the logical cores 112 may also be referred to as “virtual execution units,” “virtual cores,” or “virtual processors.” A logical core 112 may include an instruction pipeline and a data pipeline that may be separate from the instruction pipelines and data pipelines of other logical cores 112. In some embodiments, different ones of the logical cores 112 may be statically assigned to different ones of the physical cores 108, while in other embodiments, the assignment of logical cores 112 to physical cores 108 may be dynamic (e.g., the physical cores 108 may serve as a “pool” from which logical cores 112 may be dynamically assigned).

Although the number N of logical cores 112 in FIG. 1 is shown as equal to the number N of software execution contexts 120, the number of logical cores 112 may be greater than or less than the number of software execution contexts 120 in various embodiments. The SMT logic 110 may control execution of instructions from more than one thread in a particular pipeline stage at a time. The SMT logic 110 may provide the ability to fetch instructions from multiple threads in a cycle, and a larger register file to hold data from multiple threads. The number of logical cores 112 per physical core 108 may take any suitable value; in some embodiments, the SMT logic 110 may support between 2 and 8 logical cores 112 per physical core 108.

The SMT logic 110 may associate different instances of the software execution contexts 120 with different ones of the logical cores 112 so that operations of a particular software execution context 120 are executed by a given, associated logical core 112. In FIG. 1, this is illustrated as software execution context 120-1 being associated with logical core 112-1, software execution context 120-2 being associated with logical core 112-2, etc. As noted above, different ones of the logical cores 112 may share the same underlying physical core 108; for example, the logical core 112-1 and the logical core 112-2 may be implemented with a single, common underlying physical core 108.

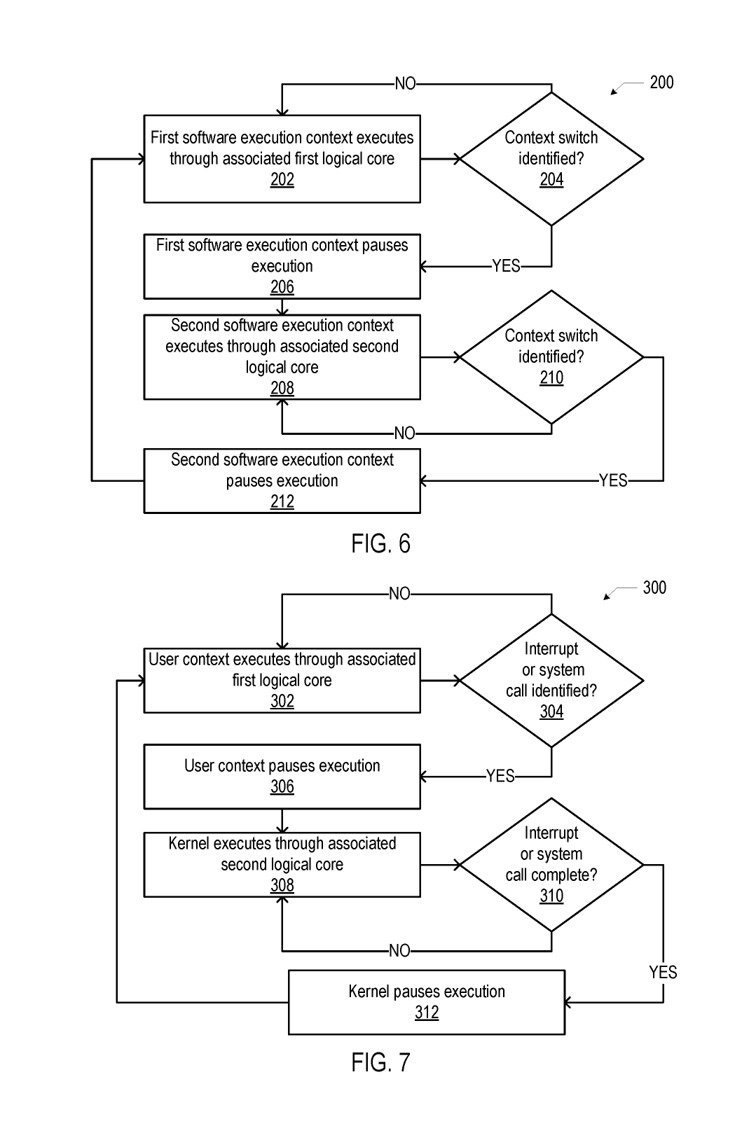

In some embodiments, operations of one of the software execution contexts 120 may be executed non-concurrently with operations of another of the software execution contexts 120. For example, if the logical core 112-1 (associated with the software execution context 120-1) shares an underlying physical core 108 with the logical core 112-2 (associated with the software execution context 120-2), execution of operations of the software execution contexts 120-1 and 120-2 may “take turns” utilizing the underlying resources of the physical core 108; operations of the software execution context 120-1 may be performed, then operations of the software execution context 120-2 may be performed, etc. In embodiments in which more than two logical cores 112 share a same underlying physical core 108 (e.g., a same physical execution unit), the associated more than two software execution contexts 120 may similarly “take turns” using the resources of that physical core 108 In embodiments in which operations of one software execution context 120 are executed non-concurrently with operations of another software execution context 120, the switch between operations of the different software execution contexts 120 may be triggered by a context switch (e.g., as discussed further below with reference to FIG. 6). For example, when a first software execution context is blocked from execution pending an external event (e.g., network activity or disk I/O) or needs to pause to switch to a second software execution context (e.g., when user code needs to pause for a system call), the logical core associated with the first software execution context pauses while the logical core associated with the second software execution context runs (e.g., to service the system call); the process may reverse to return to execution of the first software execution context (e.g., when the system call returns).

In some embodiments, operations of one of the software execution contexts 120 may be executed concurrently, or in parallel with, operations of another of the software execution contexts 120. For example, if the logical core 112-1 (associated with the software execution context 120-1) does not share an underlying physical core 108 with the logical core 112-2 (associated with the software execution context 120-2), execution of operations of the software execution contexts 120-1 and 120-2 may not need to take turns utilizing the underlying resources of a shared physical core 108, and thus operations of the software execution contexts 120-1 and 120-2 may be performed concurrently. In another example, two logical cores 112 may share an underlying physical core 108, and may also operate concurrently. For example, in a computing device 100 that includes a smaller number of more “complex” (and therefore, more expensive) physical execution units and a larger number of less complex (and therefore, less expensive) physical execution units, the more complex physical execution units (e.g., vector processors or floating point units) may be shared by multiple logical cores 112. For example, in some embodiments, interrupt service routines and kernel threads of a kernel 102 may run in parallel with processes 104 of a user context 106, as discussed further below.

In some embodiments, the registers of one or more of the software execution contexts 120 may be visible to one or more of the other software execution contexts 120; context switches may be based on monitoring these registers (e.g., to detect that a software execution context 120 is ready for a switch to another software execution context 120). For example, registers of a user context 106 (discussed further below) may be visible to a kernel 102 (discussed further below) without having the registers be saved into a stack; the kernel 102 may trigger a context switch upon monitoring the registers of the user context 106 and detecting that the user context 106 is requesting service. This type of operation may not require any additional effort on the part of the user context 106; the kernel 102 itself may investigate the user registers to determine the appropriate service to provide.

FIGS. 2-5 illustrate various particular examples of the CASMT computing device 100 of FIG. 1. Although FIGS. 2-5 illustrate particular examples of software execution contexts 120, the computing devices 100 of FIGS. 2-5 may include software execution contexts 120 in addition to those shown. Further, although FIGS. 2-5 illustrate a particular number of logical cores 112 (equal to the number of illustrated software execution contexts 120), this is simply for ease of illustration, and the computing devices 100 of FIGS. 2-5 may include more logical cores 112.

FIG. 2 illustrates a CASMT computing device 100 in which the software execution context 120-1 is a kernel 102 (e.g., associated with a particular OS) and the software execution context 120-2 is a user context 106. As illustrated in FIG. 2, one or more processes 104 may run in the user context 106. The processes 104 discussed herein may include any kind of data processing (e.g., image processing, audio processing, text processing, mathematical processing, machine learning, simulation), communication (e.g., network communication, voice or video communication), storage, or other kind of application.

The kernel 102 may be associated with a logical core 112-1, and the user context 106 may be associated with a logical core 112-2; the SMT logic 110 may direct execution of operations of the kernel 102 to the logical core 112-1, and the SMT logic 110 may direct execution of operations of the user context 106 (e.g., execution of the processes 104) to the logical core 112-2. In some embodiments, the logical cores 112-1 and 112-2 may share an underlying physical core 108, while in other embodiments, the logical cores 112-1 and 112-2 may be associated with different underlying physical cores 108. In embodiments in which operations of the kernel 102 are executed non-concurrently with operations of the user context 106, the switch between operations of the kernel 102 and the user context 106 may be triggered by a system call or the completion of a system call (e.g., as discussed further below with reference to FIG. 7). The logical core 112-1 associated with the kernel 102 may exclusively handle interrupts and faults, which may lower the impact of interrupts and faults on the performance of the processes 104 of the user context 106 since the user context 106 need not be saved and restored at each interrupt or fault.

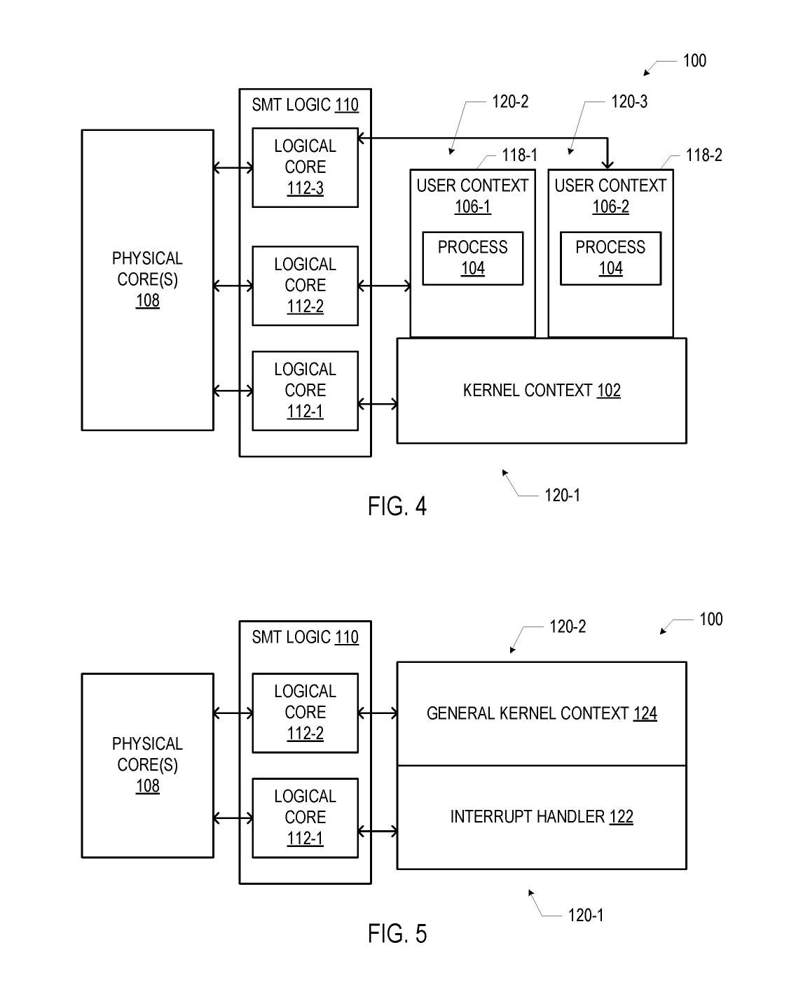

The CASMT computing device 100 of FIG. 2 (or any of the other accompanying figures) may be used for any of a number of applications. For example, the user context 106 of FIG. 2 (or FIG. 4) may be used to run one or more processes 104 that emulate the operation of another computing system (e.g., as an in-circuit emulator (ICE)); the emulation may be stopped when a fault occurs (e.g., when the emulation reaches an opcode that cannot be handled natively) as if the system being emulated was implemented in hardware. At this point, the kernel 102 may be executed to address the fault (e.g., implement the opcode that couldn't be handled natively), and then the user context 106 may return to continue the emulation. More generally, any two different software execution contexts 120 may be used together to perform emulation (in one software execution context 120) and debugging/fault servicing of the emulation (in the other software execution context 120). Using a CASMT computing device 100 to perform emulation/debugging may have significant performance advantages relative to conventional computing devices, at least because the performance “cost” of switching between emulation and fault handling is reduced; thus, CASMT computing devices 100 may extend the useful range of applications of emulation environments.

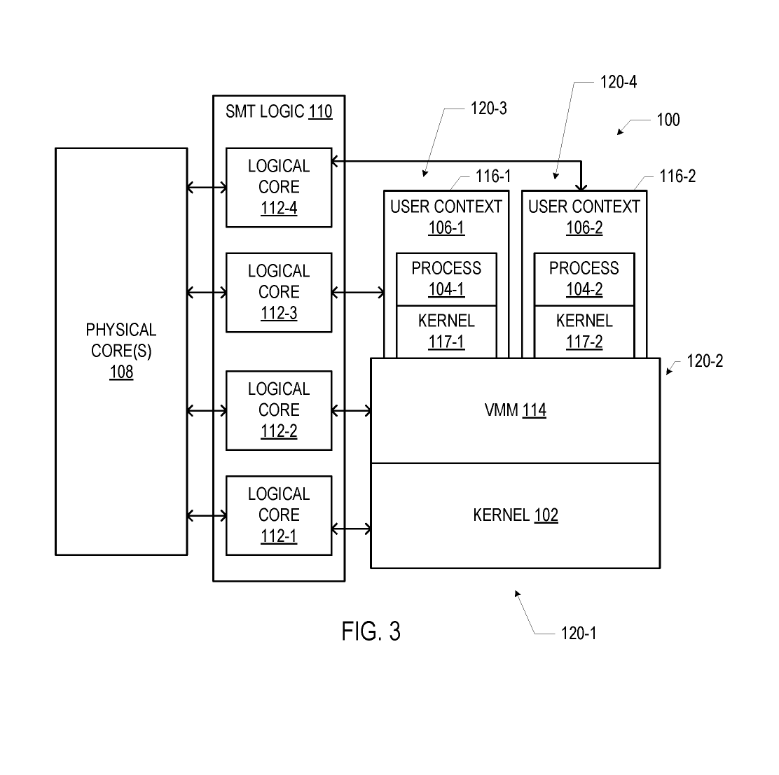

FIG. 3 illustrates a CASMT computing device 100 in which the software execution context 120-1 is a kernel 102, the software execution context 120-2 is a VMM 114, the software execution context 120-3 is a VM 116-1, and the software execution context 120-4 is another VM 116-2. The VMs 116 each have their own kernel 117, and provide an associated user context 106 in which one or more processes 104 run. As known in the art, each VM 116 may provide a separate instantiation of a guest OS (the kernels 117), binaries/libraries (not shown), and processes 104 running on top of the guest OS. The processes 104 running in the VMs 116 may be any suitable application, such as video caching, transcoding, etc. In some embodiments, a VM 116 may utilize a set of OpenStack Services running on the VMM 114. The kernel 102 may be associated with a logical core 112-1, the VMM 114 may be associated with a logical core 112-2, the VM 116-1 may be associated with a logical core 112-3, and the VM 116-2 may be associated with a logical core 112-4; the SMT logic 110 may direct execution of operations of the kernel 102 to the logical core 112-1, may direct execution of operations of the VMM 114 to the logical core 112-2, may direct execution of operations of the VM 116-1 (e.g., execution of the process(es) 104-1) to the logical core 112-3, and may direct execution of operations of the VM 116-2 (e.g., execution of the processes 104-2) to the logical core 112-4. In some embodiments, more or fewer VMs 116 may be present. In some embodiments, one or more of the logical cores 112 of the CASMT computing device 100 of FIG. 3 may share one or more underlying physical cores 108. In embodiments in which operations of one of the software execution contexts 120 of FIG. 3 are executed non-concurrently with operations of another of the software execution contexts 120 of FIG. 3 (e.g., when operations of the VMs 116 are executed non-concurrently with operations of the VMM 114), the switch between operations of the different software execution contexts 120 may be triggered by a context switch (e.g., as discussed further below with reference to FIG. 6).

FIG. 4 illustrates a CASMT computing device 100 in which the software execution context 120-1 is a kernel 102, the software execution context 120-2 is a container 118-1, and the software execution context 120-3 is another container 118-2. The containers 118 share the kernel 102, and may each provide an associated user context 106 in which one or more processes 104 run (e.g., to provide process group isolation). A container control application (e.g., a docker daemon, not shown) may manage the creation and operation of the containers 118, as known in the art. A container 118 may include binaries/libraries (not shown) shared among one or more processes 104 running in the container 118. The kernel 102 may be associated with a logical core 112-1, the container 118-1 may be associated with a logical core 112-2, and the container 118-2 may be associated with a logical core 112-3; the SMT logic 110 may direct execution of operations of the kernel 102 to the logical core 112-1, may direct execution of operations of the container 118-1 (e.g., execution of the processes 104-1) to the logical core 112-2, and may direct execution of operations of the container 118-2 (e.g., execution of the process(es) 104-2) to the logical core 112-3. In some embodiments, more or fewer containers 118 may be present. In some embodiments, one or more of the logical cores 112 of the CASMT computing device 100 of FIG. 4 may share one or more underlying physical cores 108. In embodiments in which operations of one of the software execution contexts 120 of FIG. 4 are executed non-concurrently with operations of another of the software execution contexts 120 of FIG. 4 (e.g., when operations of the containers 118 are executed non-concurrently with operations of the kernel 102), the switch between operations of the different software execution contexts 120 may be triggered by a context switch (e.g., as discussed further below with reference to FIG. 6).

FIG. 5 illustrates a CASMT computing device 100 in which the software execution context 120-1 is an interrupt handler 122 and the software execution context 120-2 is a general kernel context 124 (including the functionality of the kernel 102 that is not the interrupt handler 122). The interrupt handler 122 may be associated with a logical core 112-1, and the general kernel context 124 may be associated with a logical core 112-2; the SMT logic 110 may direct execution of operations of the interrupt handler 122 to the logical core 112-1, and the SMT logic 110 may direct execution of operations of the general kernel context 124 (e.g., execution of operations of the kernel 102 that are not handled by the interrupt handler 122) to the logical core 112-2. In some embodiments, the logical cores 112-1 and 112-2 may share an underlying physical core 108, while in other embodiments, the logical cores 112-1 and 112-2 may be associated with different underlying physical cores 108. In embodiments in which operations of the interrupt handler 122 are executed non-concurrently with operations of the general kernel context 124, the switch between operations of the interrupt handler 122 and the general kernel context 124 may be triggered by an interrupt (e.g., as discussed further below with reference to FIG. 7).

The CASMT computing devices 100 of FIGS. 1-5 may improve security by constraining different software execution contexts 120 to operate only on an associated one of the logical cores 112, reducing the likelihood of certain types of undesirable information leaks between software execution contexts 120. For example, kernel information leaks or stack-based exploits may be less likely when other software execution contexts 120 (e.g., the user context 106) operate on different logical cores 112 than the kernel 102. Further, if only one of the logical cores 112 is associated with an software execution context 120 that has supervisor-level privileges (e.g., ring 0), the other logical cores 112 may be prohibited in hardware from performing supervisor-level operations (e.g., access certain regions of memory, or modify system state registers), limiting the ability of other software execution contexts 120 to engage in unauthorized activity.

The SMT logic 110 may control the concurrent or non-concurrent execution of operations of various ones of the software execution contexts 120 on associated ones of the logical cores 112 in a CASMT computing device in any suitable manner. For example, FIGS. 6-9 are flow diagrams illustrating example methods of operating a CASMT computing device 100, in accordance with various embodiments. Although the operations of the methods of FIGS. 6-9 may be discussed as performed by the SMT logic 110 of a CASMT computing device 100, the methods may be performed by any suitable CASMT computing device component or combinations of components.

FIG. 6 illustrates a method 200 of operating a CASMT computing device (e.g., any suitable ones of the CASMT computing devices 100 disclosed herein); in the method 200, two different software execution contexts (e.g., any suitable ones of the software execution contexts 120 disclosed herein) may run non-concurrently.

At 202, a first software execution context executes through an associated first logical core. For example, operations of a software execution context 120-j may be executed by an associated logical core 112-j.

At 204, the SMT logic 110 determines whether a context switch has been identified. As used herein, a “context switch” may refer to any signal or instruction that indicates that a currently executing software execution context is to be paused so that another software execution context may run. Examples of context switches may include system calls or interrupts (e.g., as discussed below with reference to FIG. 7), faults, traps, or signals indicating that any of these context switches have been serviced. For example, a trap may cause a context switch from a VM 116 to an underlying VMM 114 (e.g., in an CASMT computing device 100 like the one discussed above with reference to FIG. 3); examples of such traps may include access to specific memory regions, time measurement operations, privileged instructions, system calls by a VM 116, or writes to an input/output (I/O) device, as well as returns from any of these traps. In some embodiments, a designated opcode may be used to initiate a context switch.

If a context switch has not been identified at 204, the method 200 returns to 202 and continues to execute the first software execution context through the first logical core. If a context switch has been identified at 204, the method 200 proceeds to 206, at which the first software execution context pauses execution.

At 208, a second software execution context executes through an associated second logical core; the second software execution context is different from the first software execution context, and the second logical core is different from the first logical core. For example, operations of a software execution context 120-k may be executed by an associated logical core 112-k.

At 210, the SMT logic 110 determines whether a context switch has been identified. Examples of context switches include any of those discussed above. For example, a trap may cause a context switch at 204 from a VM 116 to an underlying VMM 114; at 210, a servicing of the trap (e.g., completion of a trap service routine) may cause a context switch from the VMM 114 back to the VM 116.

If a context switch has not been identified at 210, the method 200 returns to 208 and continues to execute the second software execution context through the second logical core. If a context switch has been identified at 210, the method 200 proceeds to 212, at which the second software execution context pauses execution. The method 200 then returns to 202. The method 200 may be extended naturally to more than two software execution contexts operating non-concurrently.

FIG. 7 illustrates a method 300 that is a particular embodiment of the method 200 of FIG. 6, and that may be performed by the CASMT computing device 100 of FIG. 2 or FIG. 4.

At 302, a user context executes through an associated first logical core. For example, operations of a user context 106 (e.g., the user context 106 of FIG. 2 or one of the containers 118 of FIG. 4) may be executed by an associated logical core 112-j.

At 304, the SMT logic 110 determines whether an interrupt or system call has been identified. If an interrupt or system call has not been identified at 304, the method 300 returns to 302 and continues to execute the user context through the first logical core. If an interrupt or system call has been identified at 304, the method 300 proceeds to 306, at which the user context pauses execution.

At 308, the kernel (e.g., the kernel 102 of FIG. 2 or FIG. 4) executes through an associated second logical core. For example, operations of a kernel 102 may be executed by an associated logical core 112-k. The execution of the kernel may service the interrupt or system call.

At 310, the SMT logic 110 determines whether the servicing of the interrupt or system call is complete. If the servicing is not complete at 310, the method 300 returns to 308 and continues to execute the kernel through the second logical core. If the servicing is complete at 310, the method 300 proceeds to 312, at which the kernel pauses execution. The method 300 then returns to 302. The method 300 may be extended naturally to more than two software execution contexts operating non-concurrently.

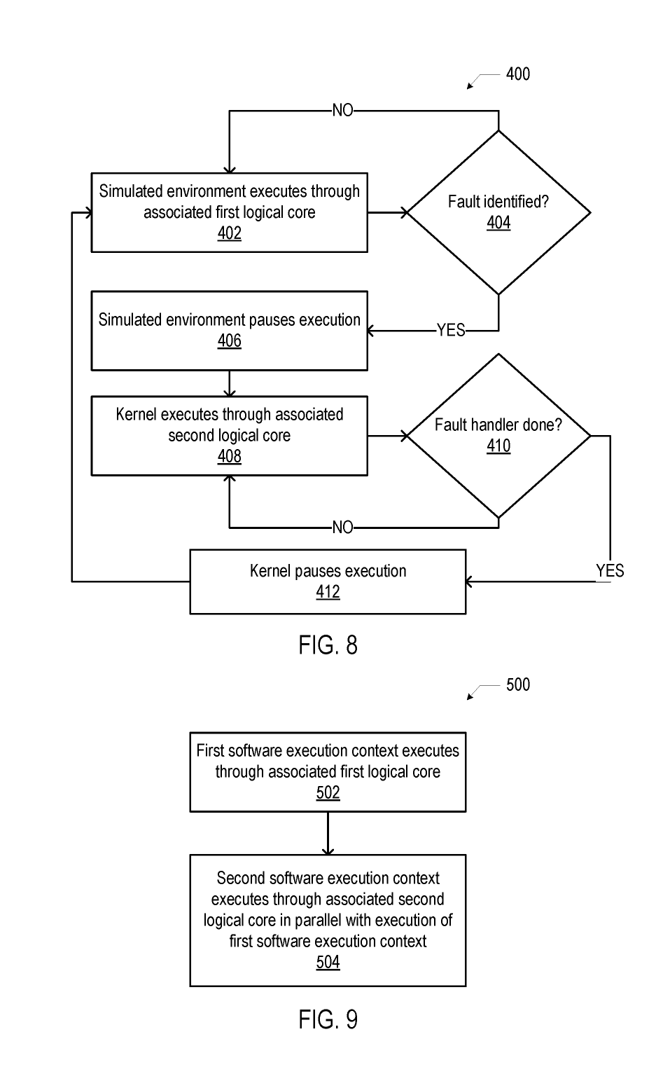

FIG. 8 illustrates a method 400 that is a particular embodiment of the method 200 of FIG. 6, and that may be performed by the CASMT computing device 100 of FIG. 2 or FIG. 4 when the user context 106 is performing emulation operations.

At 402, a simulated environment (e.g., in a user context 106) executes through an associated first logical core. For example, operations of a simulated environment (e.g., the user context 106 of FIG. 2 or one of the containers 118 of FIG. 4) may be executed by an associated logical core 112-j.

At 404, the SMT logic 110 determines whether a fault in the simulation has been identified. If fault has not been identified at 404, the method 400 returns to 402 and continues to execute the simulated environment through the first logical core. If a fault has been identified at 404, the method 400 proceeds to 406, at which the simulated environment pauses execution.

At 408, the kernel (e.g., the kernel 102 of FIG. 2 or FIG. 4) executes through an associated second logical core. For example, operations of a kernel 102 may be executed by an associated logical core 112-k. The execution of the kernel may service the fault or allow debug operations to be performed.

At 410, the SMT logic 110 determines whether the fault handler is done with its task. If the fault handler is not done at 410, the method 400 returns to 408 and continues to execute the kernel through the second logical core. If the fault handler is done at 410, the method 400 proceeds to 412, at which the kernel pauses execution. The method 400 then returns to 402. The method 400 may be extended naturally to more than two software execution contexts operating non-concurrently.

FIG. 9 illustrates a method 500 of operating a CASMT computing device (e.g., any suitable ones of the CASMT computing devices 100 disclosed herein); in the method 500, two different software execution contexts (e.g., any suitable ones of the software execution contexts 120 disclosed herein) may run concurrently.

At 502, a first software execution context may execute through an associated first logical core. For example, operations of a software execution context 120-j may be executed by an associated logical core 112-j.

At 504, a second software execution context may execute through an associated second logical core in parallel with execution of the first software execution context. For example, operations of a software execution context 120-k may be executed by an associated logical core 112-k. In some embodiments, the logical cores 112-j and 112-k may be implemented by different underlying physical cores 108.

FIGS. 1-5 only illustrate a portion of a CASMT computing device 100, and CASMT computing devices 100 may include a number of additional components. For example, FIG. 10 is a block diagram of a CASMT computing device 100, in accordance with various embodiments; any of the CASMT computing devices 100 may include the components illustrated in FIG. 10. The CASMT computing device 100 of FIG. 10 may include a processor system 610, a system memory 628, and a bus 612 through which the processor system 610 in the system memory 628 may communicate. The computing device 100 may also include I/O interfaces and/or devices 630. The I/O interfaces and/or devices 630 may include any suitable I/O devices and/or interfaces, such as any of the I/O devices and/or interfaces discussed below with reference to FIG. 13. In some embodiments, the CASMT computing device 100 may be a server (e.g., a monolithic or disaggregated server). For example, the CASMT computing device 100 may be a server in a data center, and may be one of many CASMT computing devices 100 acting as servers in the data center, as discussed below with reference to FIG. 12. In other embodiments, the CASMT computing device 100 of FIG. 10 may be a desktop, laptop, handheld, mobile, wearable, or other computing device.

The processor system 610 may include one or more physical cores 108. In the example CASMT computing device 100 illustrated in FIG. 10, N different physical cores 108 are illustrated (identified as physical cores 108-1, 108-2, . . . , 108-N).

Each of the physical cores 108 may have an associated ISA; different ones of the physical cores 108 may have different ISAs, or the same ISA. In some embodiments, the processor system 610 may be a CPU having multiple physical cores 108, or different combinations of the physical cores 108 may provide different CPUs.

The ISAs associated with different physical cores 108 may include any suitable ISA, and the processor system 610 may represent any desired combination of ISAs. Two different ISAs may have sets of operation codes (opcodes) that are not the same, nor is the set of opcodes for one of the ISAs a subset of the set of opcodes for the other ISA. An ISA may specify how and where operands are stored, how many operands are named in an instruction, what operations are available, and/or the type and size of operands.

In some embodiments, one or more of the physical cores 108 may have a complex instruction set computing (CISC) ISA. In some embodiments, one or more of the physical cores 108 may have a reduced instruction set computing (RISC) ISA. A physical core 108 with a CISC ISA may be a higher performance execution unit, and a physical core 108 with a RISC ISA may be a lower performance execution unit; thus, shifting data processing tasks between them may enable the CASMT computing device 100 to flexibly respond to demand and improve power consumption. In some embodiments, for example, some logical cores 112 may be associated with a physical core 108 having a CISC ISA, and some logical cores 112 may be associated with a physical core 108 having a RISC ISA; software execution contexts 120 requiring less computational power, such as the interrupt handler 122 discussed above, may be associated with logical cores 112 implemented by a physical core 108 having a RISC ISA, while software execution contexts 120 requiring more computational power, such as the user contexts 106 discussed above, may be associated with logical cores 112 implemented by a physical core 108 having a CISC ISA. In some embodiments, one or more of the physical cores 108 may have an ISA with an endianness (the order of bits of a digital value in memory) that is different from an endianness of an ISA of one or more of the other physical cores 108. In some embodiments, one or more of the physical cores 108 may have an ISA with a word size that is different from a word size of an ISA of one or more of the other physical cores 108. In some embodiments, one or more of the physical cores 108 may have an ISA whose address space differs from an address space of an ISA of one or more of the other physical cores 108 (e.g., by having different numbers of bits in an address and/or by having different data storage layouts for a same OS). In some embodiments, one or more of the physical cores 108 may have an ISA that can process a first number of operands in a single instruction, and one or more of the other physical cores 108 may have an ISA that can process a second, different number of operands in a single instruction (e.g., 3 versus 2). Examples of ISAs include Alpha, Blackfin, SPARC, x86, x86-64, AVR32, AArch64, 68 k, FR-V, Hexagon, PA-RISC, H8, IBM, M32R, Microblaze, MN103, OpenRISC, Power, ARC, PowerPC, SuperH, ARM (32- and 64-bit), MIPS, and Intel architectures (e.g., IA-32, IA-64, and Intel 64); any of these ISAs may be associated with different physical cores 108 in the CASMT computing device 100.

Each of the physical cores 108 may have an associated level 1 (L1) cache 604. Registers 606 associated with a particular physical core 108 may be included in the L1 cache 604 associated with that physical core 108, as illustrated in FIG. 10. The processor system 610 may include additional cache 608, which may include additional cache storage assigned to different physical cores 108, additional cache storage shared by different physical cores 108, or both. The processor system 610 may further include SMT logic 110 (e.g., in accordance with any of the embodiments disclosed herein).

In some embodiments, the system memory 628 may provide a coherent memory space for the different physical cores 108 in the processor system 610. All of the physical cores 108 may be able to access the system memory 628 (e.g., via the bus 612), and any suitable coherency protocol may be employed to notifying all of the physical cores 108 of changes to shared values.

In some embodiments, the system memory 628 may executable code 650. The executable code 650 may implement any of the software execution contexts 120 disclosed herein.

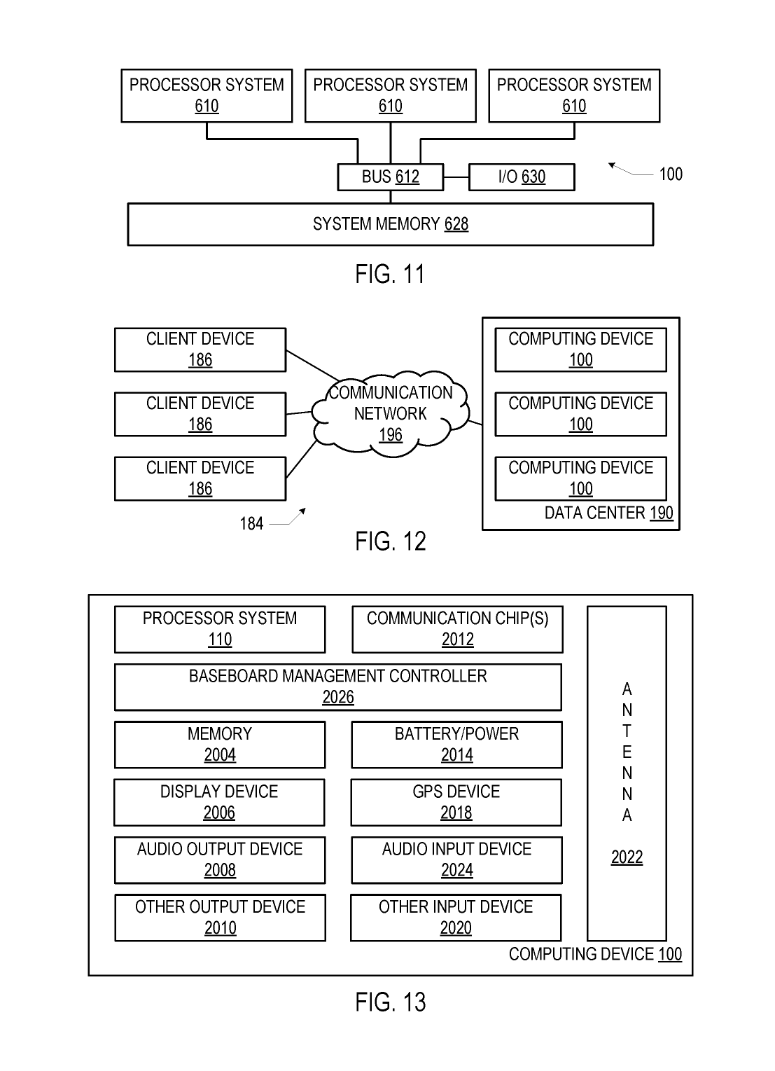

Although FIG. 10 illustrates a CASMT computing device 100 with a single processor system 610, this is simply for ease of illustration, and a CASMT computing device 100 may include any number of processor systems within which program control may be transferred. For example, FIG. 11 is a block diagram of a CASMT computing device 100 including multiple processor systems 610, in accordance with various embodiments. The processor systems 610 illustrated in FIG. 11 may have the same structure (e.g., the same numbers and ISAs of physical cores 108) or different structures (e.g., different numbers and ISAs of physical cores 108 between processor systems 610). Other components included in the CASMT computing device 100 of FIG. 11 may include any of the components discussed above with reference to the various CASMT computing devices 100. Although a particular number of processor systems 610 is shown in FIG. 11, this is simply for illustration and any number of processor systems 610 may be included in a CASMT computing device 100.

In some embodiments, the CASMT computing devices 100 disclosed herein may be used in a data center application. For example, FIG. 12 is a block diagram of a computing system 184 including a data center 190 with CASMT computing devices 100 in communication with client devices 186, in accordance with various embodiments. The client devices 186 may communicate with the CASMT computing devices 100 in the data center 190 via a communication network 196. The communication network 196 may include the Internet, a wired network, a wireless network, or any combination of communication networks. The data center 190 may also include computing devices that are not CASMT computing devices, in addition to the CASMT computing devices 100. Although a particular number of client devices 186 and CASMT computing devices 100 are shown in FIG. 12, this is simply for illustration and any number of client devices 186 and CASMT computing devices 100 may be included in a computing system 184.

Any of the programs or logic described herein as being stored in a memory (e.g., the system memory 628) of a CASMT computing device 100 may be provided to that memory in any suitable manner. In some embodiments, the memory of the CASMT computing device 100 may not include these programs or logic at the time that the CASMT computing device 100 is manufactured or shipped to a customer. For example, in some embodiments, the CASMT computing device 100 may be shipped with a disk, drive, or other non-transitory computer readable media on which any of the programs or logic described herein are stored; the programs or logic may be subsequently transferred from the computer readable media into the system memory 628. In another example, the CASMT computing device 100 may connect to a provisioning server (e.g., a remote server) and may download any of the programs or logic described herein into the system memory 628.

Although FIG. 10 illustrated some particular components of CASMT computing devices 100, the components illustrated in FIG. 10 are not exhaustive of all the components that may be included in a CASMT computing device 100. For example, FIG. 13 is a block diagram of an example CASMT computing device 100 that may serve as the CASMT computing device 100, in accordance with various embodiments. A number of elements are illustrated in FIG. 13 as included in the CASMT computing device 100, but any one or more of these elements may be omitted or duplicated, as suitable for the application. A bus (not illustrated in FIG. 13) may communicatively couple the elements of the computing device 100 of FIG. 13 (e.g., the bus 612).

Additionally, in various embodiments, the CASMT computing device 100 may not include one or more of the elements illustrated in FIG. 13, but the CASMT computing device 100 may include interface circuitry for coupling to the one or more elements. For example, the CASMT computing device 100 may not include a display device 2006, but may include display device interface circuitry (e.g., a connector and driver circuitry) to which a display device 2006 may be coupled. In another set of examples, the CASMT computing device 100 may not include an audio input device 2024 or an audio output device 2008, but may include audio input or output device interface circuitry (e.g., connectors and supporting circuitry) to which an audio input device 2024 or audio output device 2008 may be coupled.

The CASMT computing device 100 may include the processor system 610. As used herein, the term “processing device” or “processor” may refer to any device or portion of a device that processes electronic data from registers and/or memory to transform that electronic data into other electronic data that may be stored in registers and/or memory. The processor system 610 may include one or more physical cores 108, and may include also other processors, such as one or more DSPs, ASICs, CPUs, graphics processing units (GPUs), cryptoprocessors, server processors, or any other suitable processing devices. The CASMT computing device 100 may include a memory 2004, which may itself include one or more memory devices such as volatile memory (e.g., dynamic random access memory (DRAM)), non-volatile memory (e.g., read-only memory (ROM)), flash memory, solid state memory, SES, and/or a hard drive. For example, the memory 2004 may include the system memory 628.

The computing device 100 may include a baseboard management controller (BMC) 2026. The BMC 2026 is a specialized microcontroller that reads the output of sensors monitoring operational conditions of the CASMT computing device 100 (e.g., temperature, fan speeds, power consumption) and manages the interface between system-management software and platform hardware based on these readings to maintain an acceptable operating environment. Different BMCs 2026 in different CASMT computing devices 100 (e.g., in a data center 190) may communicate with each other, and remote administrators may communicate directly with the BMC 2026 to perform administrative operations. In some embodiments, the BMC 2026 may be coupled to a same circuit board (e.g., motherboard) as the physical cores 108 in the processor system 610.

In some embodiments, the CASMT computing device 100 may include a communication chip 2012 (e.g., one or more communication chips). For example, the communication chip 2012 may be configured for managing wired or wireless communications for the transfer of data to and from the CASMT computing device 100. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 2012 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 2012 may operate in accordance with a Global System for Mobile communication (GSM), General Packet Radio Service (GPRS), Universal Mobile Telecommunications System (UMTS), High Speed Packet Access (HSPA), Evolved HSPA (E-HSPA), or LTE network. The communication chip 2012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2012 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2012 may operate in accordance with other wireless protocols in other embodiments. The computing device 100 may include an antenna 2022 to facilitate wireless communications and/or to receive other wireless communications (such as AM or FM radio transmissions). In some embodiments, the computing device 100 may not include an antenna, nor wireless communication capability.

In some embodiments, the communication chip 2012 may manage wired communications, such as electrical, optical, or any other suitable communication protocols (e.g., Ethernet, Infiniband, other high performance computing (HPC) interconnects, or on-board fabrics such as QuickPath Interconnect (QPI)). The communication chip 2012 may be included in a network interface controller (NIC). As used herein, when the CASMT computing device 100 is a server, the computing device 100 may include at least the processor system 610 and a NIC. As noted above, the communication chip 2012 may include multiple communication chips. For instance, a first communication chip 2012 may be dedicated to shorter-range wireless communications such as Wi-Fi or Bluetooth, and a second communication chip 2012 may be dedicated to longer-range wireless communications such as a global positioning system (GPS), EDGE, GPRS, CDMA, WiMAX, LTE, EV-DO, or others. In some embodiments, a first communication chip 2012 may be dedicated to wireless communications, and a second communication chip 2012 may be dedicated to wired communications.

The CASMT computing device 100 may include battery/power circuitry 2014. The battery/power circuitry 2014 may include one or more energy storage devices (e.g., batteries or capacitors) and/or circuitry for coupling elements of the CASMT computing device 100 to an energy source separate from the CASMT computing device 100 (e.g., AC line power).

The CASMT computing device 100 may include a display device 2006 (or corresponding interface circuitry, as discussed above). The display device 2006 may include any visual indicators, such as a heads-up display, a computer monitor, a projector, a touchscreen display, a liquid crystal display (LCD), a light-emitting diode display, or a flat panel display, for example.

The CASMT computing device 100 may include an audio output device 2008 (or corresponding interface circuitry, as discussed above). The audio output device 2008 may include any device that generates an audible indicator, such as speakers, headsets, or earbuds, for example.

The CASMT computing device 100 may include an audio input device 2024 (or corresponding interface circuitry, as discussed above). The audio input device 2024 may include any device that generates a signal representative of a sound, such as microphones, microphone arrays, or digital instruments (e.g., instruments having a musical instrument digital interface (MIDI) output).

The CASMT computing device 100 may include a GPS device 2018 (or corresponding interface circuitry, as discussed above). The GPS device 2018 may be in communication with a satellite-based system and may receive a location of the CASMT computing device 100, as known in the art.

The CASMT computing device 100 may include an other output device 2010 (or corresponding interface circuitry, as discussed above). Examples of the other output device 2010 may include an audio codec, a video codec, a printer, a wired or wireless transmitter for providing information to other devices, or an additional storage device.

The CASMT computing device 100 may include an other input device 2020 (or corresponding interface circuitry, as discussed above). Examples of the other input device 2020 may include an accelerometer, a gyroscope, an image capture device, a keyboard, a cursor control device such as a mouse, a stylus, a touchpad, a bar code reader, a Quick Response (QR) code reader, any sensor, or a radio frequency identification (RFID) reader.

Any of the CASMT computing devices 100 disclosed herein may be implemented with a disaggregated architecture. For example, a CASMT computing device 100 may be implemented by different devices (e.g., different processing devices, different memory devices, and/or different network communication devices, etc.) on different racks in a datacenter, or across data centers, in communication with each other via any suitable fabric (e.g., electrical or optical buses). Although various ones of the figures may illustrate a CASMT computing device 100 as a monolithic device, this is simply for ease of illustration, and a CASMT computing device 100 may be disaggregated in any suitable manner. In some embodiments, different ones of the physical cores 108 in a computing device 100 may be in different racks in a datacenter, or in different datacenters (and execution of a program may be transferred between these different physical cores 108, as described herein). In some embodiments, the system memory 628 of a computing device 100 may be provided by multiple memory devices in different racks in a data center and/or in different datacenters. In some embodiments, all of the elements of a CASMT computing device 100 disclosed herein may be included in a single housing (e.g., when the CASMT computing device 100 is a desktop, laptop, or tablet or other handheld computing device).

The following paragraphs provide examples of various embodiments disclosed herein.

Example 1 is a computing device, including: one or more physical cores; and simultaneous multithreading logic to manage multiple logical cores per physical core such that operations of a first computing context are to be executed by a first logical core associated with the first computing context and operations of a second computing context are to be executed by a second logical core associated with the second computing context, wherein the first logical core and the second logical core share a common physical core.

Example 2 includes the subject matter of Example 1, and further specifies that the first computing context is a kernel and the second computing context is a user context.

Example 3 includes the subject matter of Example 1, and further specifies that the first computing context is a VMM and the second computing context is a VM.

Example 4 includes the subject matter of Example 3, and further specifies that the simultaneous multithreading logic is to manage the multiple logical cores per physical core such that operations of a third computing context are to be executed by a third logical core associated with the third computing context, the second computing context is a first VM, and the third computing context is a second VM.

Example 5 includes the subject matter of Example 1, and further specifies that the first computing context is a kernel and the second computing context is a container.

Example 6 includes the subject matter of Example 1, and further specifies that the first computing context includes an in-circuit emulator and the second computing context is to handle faults of the in-circuit emulator.

Example 7 includes the subject matter of Example 1, and further specifies that the first computing context is an interrupt handler.

Example 8 includes the subject matter of any of Examples 1-7, and further specifies that the simultaneous multithreading logic is to switch from executing operations of the second computing context by the second logical core to executing operations of the first computing context by the first logical core in response to a system call.

Example 9 includes the subject matter of any of Examples 1-8, and further specifies that registers of the second computing context are visible to the first computing context.

Example 10 includes the subject matter of any of Examples 1-9, and further specifies that the common physical core has a RISC architecture.

Example 11 includes the subject matter of any of Examples 1-9, and further specifies that the common physical core has a CISC architecture.

Example 12 includes the subject matter of any of Examples 1-11, and further specifies that operations of the first computing context are to be executed by the first logical core in parallel with operations of the second computing context executed by the second logical core.

Example 13 includes the subject matter of any of Examples 1-11, and further specifies that operations of the first computing context are to be executed by the first logical core non-concurrently with operations of the second computing context executed by the second logical core.

Example 14 includes the subject matter of any of Examples 1-13, and further specifies that the simultaneous multithreading logic is to switch from executing operations of the first computing context by the first logical core to executing operations of the second computing context by the second logical core in response to completion of a system call.

Example 15 includes the subject matter of any of Examples 1-14, and further specifies that the computing device is a server.

Example 16 includes the subject matter of any of Examples 1-15, and further specifies that the computing device is a desktop computing device or a laptop computing device.

Example 17 includes the subject matter of any of Examples 1-16, and further specifies that the computing device is a handheld computing device.

Example 18 is a computing device, including: one or more physical processing units; and logic to manage multiple logical processing units per physical processing unit such that operations of a first software execution context are to be executed by a first logical processing unit associated with the first software execution context and operations of a second software execution context are to be executed by a second logical processing unit associated with the second software execution context, wherein the operations of the second software execution context are not executed by the first logical processing unit.

Example 19 includes the subject matter of Example 18, and further specifies that the one or more physical processing units are processing cores.

Example 20 includes the subject matter of any of Examples 18-19, and further specifies that the operations of the first software execution context are not executed by the second logical processing unit.

Example 21 includes the subject matter of any of Examples 18-20, and further specifies that the logic is to present the multiple logical processing units to the first software execution context.

Example 22 includes the subject matter of any of Examples 18-21, and further specifies that the first software execution context is a kernel and the second software execution context is a user context.

Example 23 includes the subject matter of any of Examples 18-21, and further specifies that the first software execution context is a VMM and the second software execution context is a VM.

Example 24 includes the subject matter of Example 23, and further specifies that the logic is to manage the multiple logical processing units per physical processing unit such that operations of a third software execution context are to be executed by a third logical processing unit associated with the third software execution context, the second software execution context is a first VM, and the third software execution context is a second VM.

Example 25 includes the subject matter of Example 18, and further specifies that the first software execution context is a kernel and the second software execution context is a container.

Example 26 includes the subject matter of Example 25, and further specifies that the logic is to manage the multiple logical processing units per physical processing unit such that operations of a third software execution context are to be executed by a third logical processing unit associated with the third software execution context, the second software execution context is a first container, and the third software execution context is a second container.

Example 27 includes the subject matter of Example 18, and further specifies that the first software execution context is an interrupt handler.

Example 28 includes the subject matter of any of Examples 18-26, and further specifies that the logic is to switch from executing operations of the second software execution context by the second logical processing unit to executing operations of the first software execution context by the first logical processing unit in response to a system call.

Example 29 includes the subject matter of any of Examples 18-28, and further specifies that registers of the second software execution context are visible to the first software execution context.

Example 30 includes the subject matter of any of Examples 18-29, and further specifies that at least one of the physical processing units has a RISC architecture.

Example 31 includes the subject matter of any of Examples 18-29, and further specifies that at least one of the physical processing units has a CISC architecture.

Example 32 includes the subject matter of any of Examples 18-31, and further specifies that operations of the first software execution context are to be executed by the first logical processing unit in parallel with operations of the second software execution context executed by the second logical processing unit.

Example 33 includes the subject matter of any of Examples 18-31, and further specifies that operations of the first software execution context are to be executed by the first logical processing unit non-concurrently with operations of the second software execution context executed by the second logical processing unit.

Example 34 includes the subject matter of any of Examples 18-33, and further specifies that the logic is to switch from executing operations of the first software execution context by the first logical processing unit to executing operations of the second software execution context by the second logical processing unit in response to completion of a system call.

Example 35 includes the subject matter of any of Examples 18-34, and further specifies that the computing device is a server.

Example 36 includes the subject matter of any of Examples 18-34, and further specifies that the computing device is a desktop computing device or a laptop computing device.

Example 37 includes the subject matter of any of Examples 18-34, and further specifies that the computing device is a handheld computing device.

Example 38 includes the subject matter of any of Examples 18-34, and further includes: interprocess communication (IPC) logic.

Example 39 is one or more non-transitory computer readable media having instructions thereon that, in response to execution by processing circuitry of a computing device, cause the computing device to: present multiple logical processing units per physical processing unit of the computing device; determine a first logical processing unit associated with a first software execution context; cause operations of the first software execution context to be executed by the first logical processing unit; determine a second logical processing unit associated with a second software execution context; and cause operations of the second software execution context to be executed by the second logical processing unit.

Example 40 includes the subject matter of Example 39, and further specifies that the first logical processing unit and the second logical processing unit share a common physical processing unit.

Example 41 includes the subject matter of any of Examples 39-40, and further specifies that the physical processing unit is a processing core.

Example 42 includes the subject matter of any of Examples 39-41, and further specifies that the operations of the first software execution context are not executed by the second logical processing unit.

Example 43 includes the subject matter of any of Examples 39-42, and further specifies that the first software execution context is a kernel and the second software execution context is a user context.

Example 44 includes the subject matter of any of Examples 39-42, and further specifies that the first software execution context is a VMM and the second software execution context is a VM.

Example 45 includes the subject matter of Example 44, and further includes instructions thereon that, in response to execution by processing circuitry of the computing device, cause the computing device to: determine a third logical processing unit associated with a third software execution context; and cause operations of the third software execution context to be executed by the third logical processing unit.

Example 46 includes the subject matter of Example 45, and further specifies that the first software execution context is a VMM, the second software execution context is a first VM, and the third software execution context is a second VM.

Example 47 includes the subject matter of Example 45, and further specifies that the first software execution context is a kernel, the second software execution context is a first container, and the third software execution context is a second container.

Example 48 includes the subject matter of Example 39, and further specifies that the first software execution context is a kernel and the second software execution context is a container.

Example 49 includes the subject matter of Example 39, and further specifies that the first software execution context is an interrupt handler.

Example 50 includes the subject matter of any of Examples 39-49, and further includes instructions thereon that, in response to execution by processing circuitry of the computing device, cause the computing device to: switch from executing operations of the second software execution context by the second logical processing unit to executing operations of the first software execution context by the first logical processing unit in response to a system call.

Example 51 includes the subject matter of any of Examples 39-49, and further specifies that registers of the second software execution context are visible to the first software execution context.

Example 52 includes the subject matter of any of Examples 39-51, and further specifies that at least one physical processing unit of the computing device has a RISC architecture.

Example 53 includes the subject matter of any of Examples 39-51, and further specifies that at least one physical processing unit of the computing device has a CISC architecture.

Example 54 includes the subject matter of any of Examples 39-53, and further specifies that operations of the first software execution context are to be executed by the first logical processing unit in parallel with operations of the second software execution context executed by the second logical processing unit.

Example 55 includes the subject matter of any of Examples 39-53, and further specifies that operations of the first software execution context are to be executed by the first logical processing unit non-concurrently with operations of the second software execution context executed by the second logical processing unit.

Example 56 includes the subject matter of any of Examples 39-55, and further includes instructions thereon that, in response to execution by processing circuitry of the computing device, cause the computing device to: switch from executing operations of the first software execution context by the first logical processing unit to executing operations of the second software execution context by the second logical processing unit in response to completion of a system call.

Example 57 includes the subject matter of any of Examples 39-56, and further specifies that the computing device is a server.

Example 58 includes the subject matter of any of Examples 39-56, and further specifies that the computing device is a desktop computing device or a laptop computing device.

Example 59 includes the subject matter of any of Examples 39-56, and further specifies that the computing device is a handheld computing device.

Example 60 is a method of operating simultaneous multithreading logic, including: presenting multiple logical cores per at least one physical core of a computing device; directing execution of operations of a first computing context to a first logical core; and directing execution of operations of a second computing context to a second logical core.

Example 61 includes the subject matter of Example 60, and further specifies that the first logical core and the second logical core share a common physical core.

Example 62 includes the subject matter of any of Examples 60-61, and further specifies that the first computing context is a kernel and the second computing context is a user context.

Example 63 includes the subject matter of Example 62, and further specifies that the user context includes an in-circuit emulator.

Example 64 includes the subject matter of Example 60, and further specifies that the first computing context is a VMM and the second computing context is a VM.

Example 65 includes the subject matter of Example 64, and further includes: directing execution of operations of a third computing context to a third logical core; wherein the second computing context is a first VM, and the third computing context is a second VM.

Example 66 includes the subject matter of Example 65, and further includes: directing execution of operations of a fourth computing context to a fourth logical core, wherein the fourth computing context is a kernel.

Example 67 includes the subject matter of any of Examples 60-66, and further includes: directing execution of operations of a third computing context to a third logical core.

Example 68 includes the subject matter of any of Examples 60-66, and further includes: directing execution of operations of a third computing context to a third logical core; wherein the first computing context is a kernel, the second computing context is a first container, and the third computing context is a second container.

Example 69 includes the subject matter of any of Examples 60-67, and further specifies that the first computing context is a kernel and the second computing context is a container.

Example 70 includes the subject matter of any of Examples 60-67, and further specifies that the first computing context is an interrupt handler.

Example 71 includes the subject matter of any of Examples 60-70, and further includes:

causing a switch from execution of operations of the second computing context by the second logical core to execution of operations of the first computing context by the first logical core in response to a system call.

Example 72 includes the subject matter of any of Examples 60-71, and further specifies that registers of the second computing context are visible to the first computing context.

Example 73 includes the subject matter of any of Examples 60-72, and further specifies that the at least one physical core has a RISC architecture.

Example 74 includes the subject matter of any of Examples 60-72, and further specifies that the at least one physical core has a CISC architecture.

Example 75 includes the subject matter of any of Examples 60-74, and further specifies that operations of the first computing context are to be executed by the first logical core in parallel with operations of the second computing context executed by the second logical core.

Example 76 includes the subject matter of any of Examples 60-74, and further specifies that operations of the first computing context are to be executed by the first logical core non-concurrently with operations of the second computing context executed by the second logical core.

Example 77 includes the subject matter of any of Examples 60-76, and further includes: causing a switch from execution of operations of the first computing context by the first logical core to execution of operations of the second computing context by the second logical core in response to completion of a system call.

Example 78 includes the subject matter of any of Examples 60-77, and further specifies that the computing device is a server.

Example 79 includes the subject matter of any of Examples 60-77, and further specifies that the computing device is a desktop computing device or a laptop computing device.

Example 80 includes the subject matter of any of Examples 60-77, and further specifies that the computing device is a handheld computing device.

Example 81 includes means for performing the method of any of Examples 60-80.

1. A computing device, comprising:
one or more physical cores; and
simultaneous multithreading logic to manage multiple logical cores per physical core such that operations of a first computing context are to be executed by a first logical core associated with the first computing context and operations of a second computing context are to be executed by a second logical core associated with the second computing context, wherein the first logical core and the second logical core share a common physical core.

2. The computing device of claim 1, wherein the first computing context is a kernel and the second computing context is a user context.

3. The computing device of claim 1, wherein the first computing context is a virtual machine manager and the second computing context is a virtual machine.

4. The computing device of claim 3, wherein the simultaneous multithreading logic is to manage the multiple logical cores per physical core such that operations of a third computing context are to be executed by a third logical core associated with the third computing context, the second computing context is a first virtual machine, and the third computing context is a second virtual machine.

5. The computing device of claim 1, wherein the first computing context includes an in-circuit emulator and the second computing context is to handle faults of the in-circuit emulator.

6. The computing device of claim 1, wherein the first computing context is an interrupt handler.

7. A computing device, comprising:
one or more physical processing units; and
logic to manage multiple logical processing units per physical processing unit such that operations of a first software execution context are to be executed by a first logical processing unit associated with the first software execution context and operations of a second software execution context are to be executed by a second logical processing unit associated with the second software execution context, wherein the operations of the second software execution context are not executed by the first logical processing unit.

8. The computing device of claim 7, wherein the one or more physical processing units are processing cores.

9. The computing device of claim 7, wherein the operations of the first software execution context are not executed by the second logical processing unit.

10. The computing device of claim 7, wherein the logic is to present the multiple logical processing units to the first software execution context.

11. The computing device of claim 7, wherein the first software execution context is a kernel and the second software execution context is a container.

12. The computing device of claim 7, wherein the computing device is a server.

13. The computing device of claim 7, wherein the computing device is a desktop computing device or a laptop computing device.

14. The computing device of claim 7, wherein the computing device is a handheld computing device.

15. One or more non-transitory computer readable media having instructions thereon that, in response to execution by processing circuitry of a computing device, cause the computing device to:
present multiple logical processing units per physical processing unit of the computing device;
determine a first logical processing unit associated with a first software execution context;
cause operations of the first software execution context to be executed by the first logical processing unit;
determine a second logical processing unit associated with a second software execution context; and
cause operations of the second software execution context to be executed by the second logical processing unit.

16. The one or more non-transitory computer readable media of claim 15, wherein the first logical processing unit and the second logical processing unit share a common physical processing unit.

17. The one or more non-transitory computer readable media of claim 15, wherein the physical processing unit is a processing core.

18. The one or more non-transitory computer readable media of claim 15, wherein registers of the second software execution context are visible to the first software execution context.

19. The one or more non-transitory computer readable media of claim 15, wherein at least one physical processing unit of the computing device has a reduced instruction set computing (RISC) architecture.

20. The one or more non-transitory computer readable media of claim 15, wherein at least one physical processing unit of the computing device has a complex instruction set computing (CISC) architecture.

21. A method of operating simultaneous multithreading logic, comprising:
presenting multiple logical cores per at least one physical core of a computing device;
directing execution of operations of a first computing context to a first logical core; and
directing execution of operations of a second computing context to a second logical core.

22. The method of claim 21, further comprising:
causing a switch from execution of operations of the second computing context by the second logical execution unit to execution of operations of the first computing context by the first logical execution unit in response to a system call.

23. The method of claim 21, wherein operations of the first computing context are to be executed by the first logical core in parallel with operations of the second computing context executed by the second logical core.

24. The method of claim 21, wherein operations of the first computing context are to be executed by the first logical core non-concurrently with operations of the second computing context executed by the second logical core.

25. The method of claim 21, further comprising:
causing a switch from execution of operations of the first computing context by the first logical core to execution of operations of the second computing context by the second logical core in response to completion of a system call.
